(19) United States
(12) Patent Application Publication
(10) Pub. No.: US 2005/0246561 A1
(43) Pub. Date: Nov. 3, 2005

(54) Computer power mangement architecture and method thereof

(76) Inventors: Tung-Peng Wu, Taipei (TW); Chi-Min Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/055,061

(22) Filed: Feb. 11, 2005

(30) Foreign Application Priority Data
Feb. 12, 2004 (TW) 93103379

(51) Int. Cl. G06F 1/26

(52) U.S. Cl. 713/300

(57) ABSTRACT

A computer power management architecture and a method thereof is disclosed. A first operating system and a second operating system with lower consumption of system resources are installed in a computer system. When a multimedia presentation unit installed in a first operating system or a second operating system runs programs, a power control unit installed in the multimedia presentation unit or the second operating system retrieves related data from a power management data unit according to the programs being executed by the multimedia presentation unit. Thus the hardware devices necessary for running the programs are switched on while unemployed hardware devices of the computer system are shut down by the power control unit. Moreover, the power control unit adjusts frequency of a central processing unit of the computer system according to the programs executed by the multimedia presentation unit so as to reduce the electricity consumption of the computer system.

### BACKGROUND OF THE INVENTION

The present invention relates to a computer power management architecture and a method thereof, especially to an architecture and a method for computer power management with lower consumption of system resources so as to achieves savings on electricity of the computer system.

By the fast development of the technology nowadays, the computer system has more powerful functions. Besides word processing such as data processing, wireless data transmission, internet and facsimile, computers offer multimedia entertainment, integrating entertainment with the data processing function. Thus the computer has become an essential tool for people. However, due to the multiple affairs deal by the computer, a lot of optional hardware devices are assembled with the computer system. When the computer system is turned on, no matter the hardware devices are used, the hardware devices are standby and consume energy. This causes a power waste that is a significant problem in portable computer systems. If the computer system can't save the electricity, its convenience will be reduced greatly.

In order to solve the above problem, power management technology has been developed. The initial power management technology takes the Advanced Power Management, APM that is a standard used by laptop computers that reduces power consumption when the system is idle.

The system activity is monitored by a basic input output system (BIOS) and certain functions are turned off when not being used. Moreover, users can decide how long after being idle, the system is switched into a suspend mode or standby mode. However, there are various peripherals connected with the computer system, the Basic Input Output System (BIOS) can't support all the peripherals and make them APM-compatible. Thus, APM can't provide effective power management once the BIOS doesn't support the hardware devices. Furthermore, the BIOS of different manufacturers have no compatibility with each other due to different specifications by manufactures. Therefore the AMP has no longer been able to meet power management requirements.

A new interface for power management—ACPI (Advanced Configuration and Power Interface) is co-developed by Hewlett-Packard, Intel, Microsoft, Phoenix, and Toshiba instead of APM. Most of the computer systems now use ACPI. ACPI establishes industry-standard interfaces for OS(Operating System)-directed configuration and power management on laptops, desktops, and servers so as to replace the nonuniform interfaces for power management developed respectively by different manufacturers. Under the ACPI, the operating system directs all computer and device power state transitions. Based on preference and knowledge of how devices are being used by programs, the operating system places devices in and out of low power states. For example, devices such as a hard disk or a screen not being used for a period of time may be turned off, or be placed in a low-power state. Since ACPI is a specification for operating system, it unifies the control in the operating system and provides users a convenient interface thus enhances power management functionality and dependability.

Although ACPI is a powerful platform for power management, it is complicated for monitoring each of components on computer systems and it also increases the loading of the CPU. Furthermore, due to the requirements for prevention of computer virus infection, system management and system stability, loadings and resources consumption of windows operating system keep increasing. Even only a single application program is used, users still need to wait for a longer time to turn on the computer system.

Therefore, the present invention provides a computer power management architecture and a method thereof which uses an architecture and a method with lower system resources consumption to manage power needs so as to reduce loading of the computer system. In accordance with the programs being executed by the computer system now, the related hardware devices for executing the programs are switched on while other idle devices are shutdown. Moreover, the frequency of the central processing unit is adjusted to a lower frequency for saving electricity and avoiding the above problems.

### SUMMARY OF THE INVENTION

It is a primary object of the present invention to provide a computer power management architecture and a method thereof that turns on hardware devices necessary for running programs that users need in a computer system and shuts down other unused hardware devices so as to lower electricity consumption and reduce loading of the computer system.

It is another object of the present invention to provide a computer power management architecture and a method thereof that adjusts working frequency of a central processing unit into a proper frequency according to programs users want to run in a computer system so as to avoid the waste of electricity due to higher frequency during executing programs.

It is a further object of the present invention to provide a computer power management architecture and a method thereof that detects current loading of the computer system and adjusts frequency of the central processing unit into a lower one so as to avoid power waste caused by higher frequency.

It is a further object of the present invention to provide a computer power management architecture and a method thereof that manages power of the computer system without instant monitoring of each hardware devices so that the loading of computer system is decreased.

A computer power management architecture and a method thereof in accordance with the present invention is composed by a first operating system and a second operating system with lower system resource consumption installed in a computer system. A multimedia presentation unit is installed in the first operating while it can also be installed in the second operating system. When the multimedia presentation unit is used to run audio/video programs, a power control unit installed in the second operating system or the multimedia presentation unit retrieves data corresponding to the program being executed by the multimedia presentation unit from a power management data unit for turning on program-related hardware devices as well as shutting down rest idle hardware devices. The power control unit can also adjust frequency of a central processing unit of the computer system. Thus electricity consumption of the computer system is reduced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an embodiment in accordance with the present invention;

FIG. 2 is a flow chart of an embodiment in accordance with the present invention;

FIG. 3 is a list showing information stored inside a power management data unit of an embodiment in accordance with the present invention;

FIG. 4 is a flow chart showing how a power control unit detects and adjusts frequency of a central processing unit of an embodiment in accordance with the present invention;

FIG. 5 a block diagram of another embodiment in accordance with the present invention.

### DETAILED DESCRIPTION OF THE PREFFERED EMBODIMENT

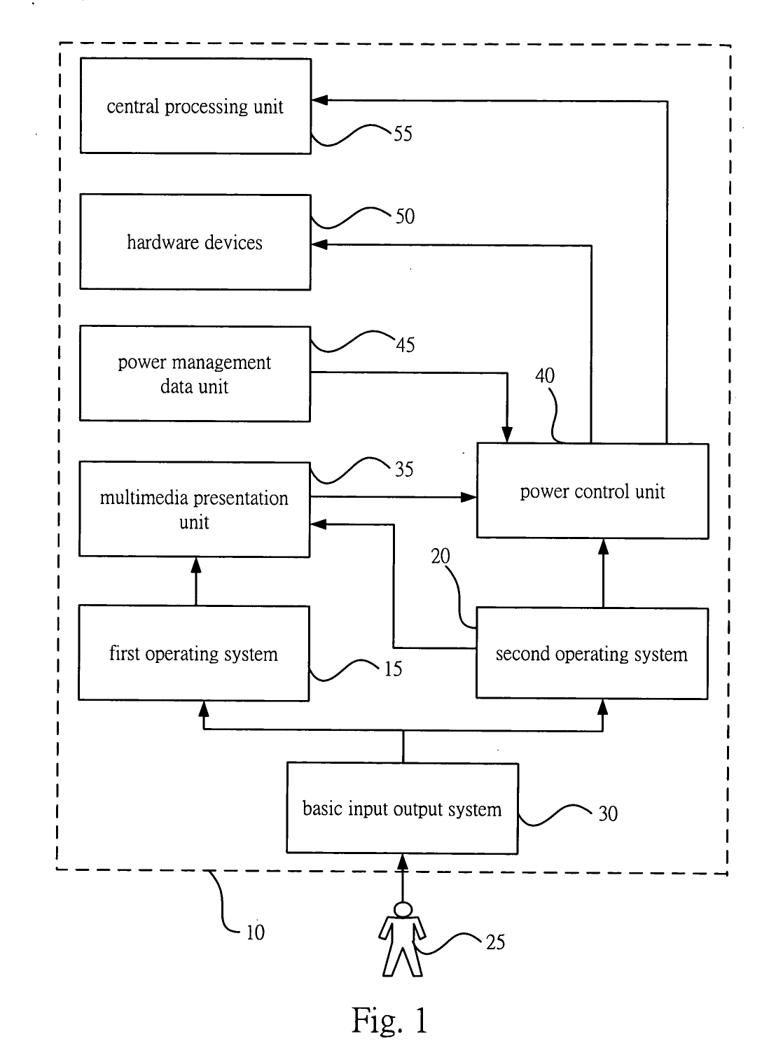

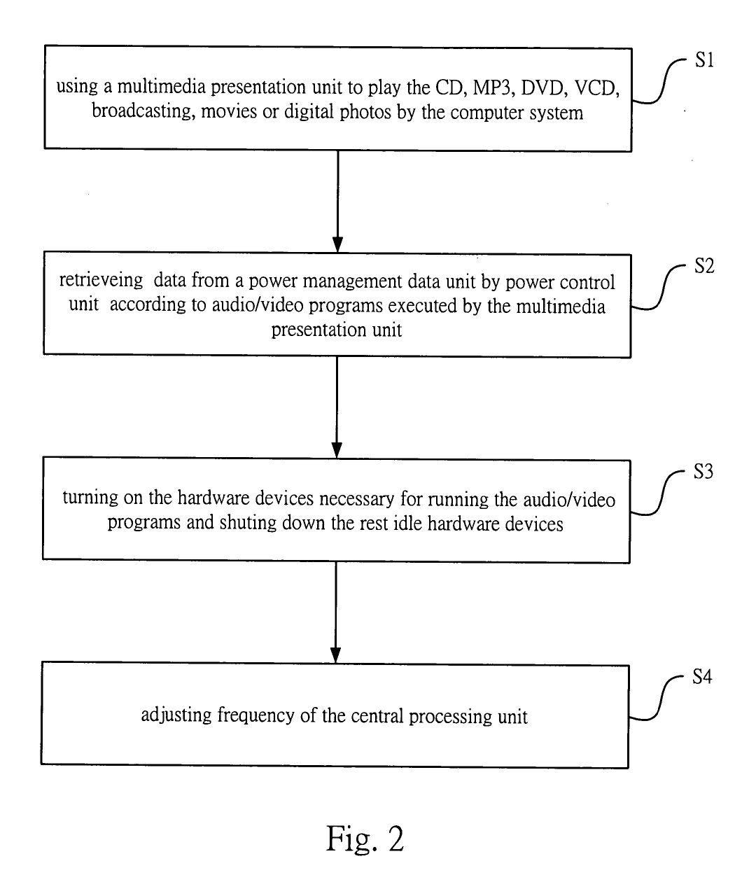

Refer to FIG. 1 & FIG. 2, the present invention includes a computer system 10, being installed with a first operating system 15 and a second operating system 20. The first operating system 15 with a plurality of application programs is a FAT or a NTFS file format, such as Windows operating systems—Windows XP, Windows NT, Window 98, Windows 2000 and Windows Me. The second operating system 20 is an operating system with lower system resource consumption, a EXT2 or a EXT3 file format, such as Linux operating systems. The second operating system 20 shares the application programs with the first operating system 15. When users 25 want to use the computer system 10, a Basic Input Output System (BIOS) 30 is “woken up” as soon as computer is turned on and then it initiates the second operating system 20. Since the BIOS 30 uses the second operating system 20 with lower resource consumption after booting, it takes less time to turn on the computer system 10 and the system resource consumption is also reduced.

As shown in step S1, when users operate the computer system 10, through the second operating system 20, a multimedia presentation unit 35 installed in the first operating system 15 is used to play the CD, MP3, DVD, VCD, broadcasting, movies or digital photos. The multimedia presentation unit 35 can also be installed in the second operating system 20. Then, refer to step S2, a power control unit 40 disposed in the second operating system 20 retrieves data from a power management data unit 45 inside the computer system 10 according to audio/video programs executed by the multimedia presentation unit 35. Each piece of the data corresponds to each of the programs run by the multimedia presentation unit 35 for turning on as well as shutting off a plurality of hardware devices 50 and adjusting frequency of a central processing unit 55.

Refer to step S3, the power control unit 40 turns on the hardware devices 50 necessary for running the audio/video programs and shuts down the rest idle hardware devices 50 to save electricity according to the data retrieved. At last, the power control unit 40 also adjusts frequency of the central processing unit 55 to prevent higher frequency of the central processing unit 55 from wasting electricity according to the data, as shown in step S4.

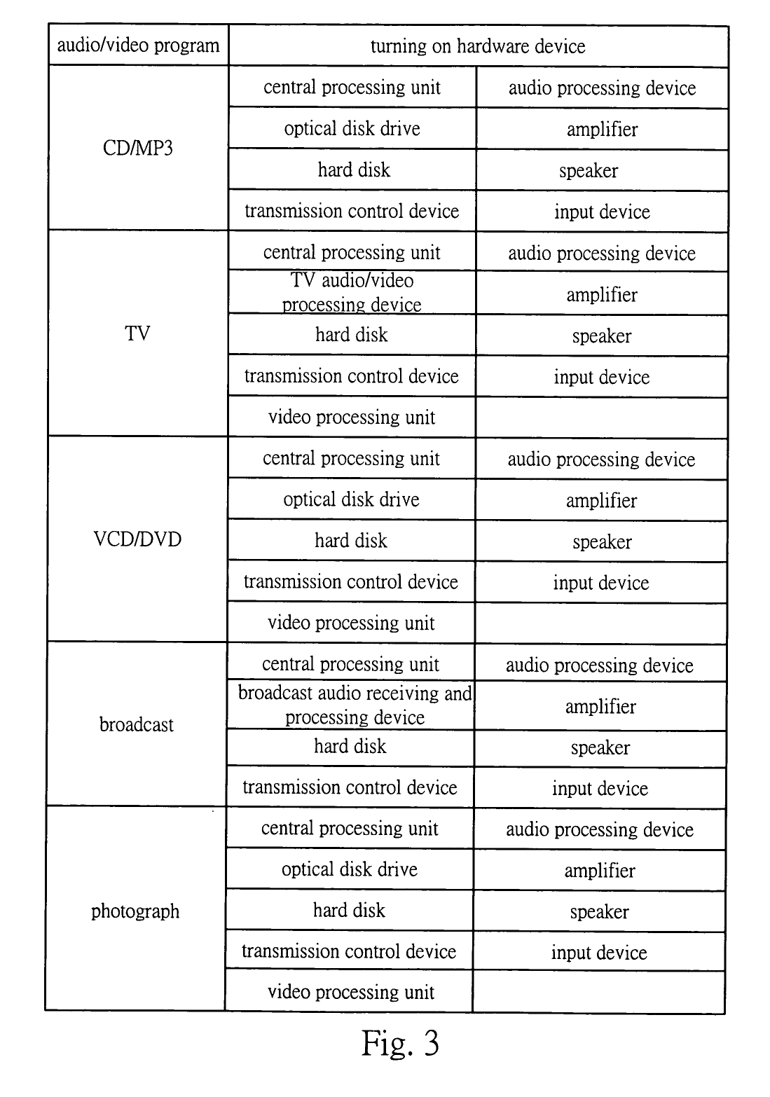

Refer to FIG. 3, a data list stored in the power management data unit 45 is disclosed. When the multimedia presentation unit 35 is playing CD and MP3 music, the power control unit 40 turns on the central processing unit 55, an optical disk drive, a hard disk, a transmission control device ( IDE ATA/ATAPI ), an audio processing device, an amplifier, a speaker and an input device such as keyboard or mouse and shuts down the rest hardware devices. In executing program for playing other video-audio items, the power control unit 40 switches on the relative hardware devices 50 necessary for the program run by the multimedia presentation unit 35 according to the information inside the power management data unit 45, as shown in FIG. 3. The data inside the power management data unit 45 further includes the frequency of the central processing unit 55.

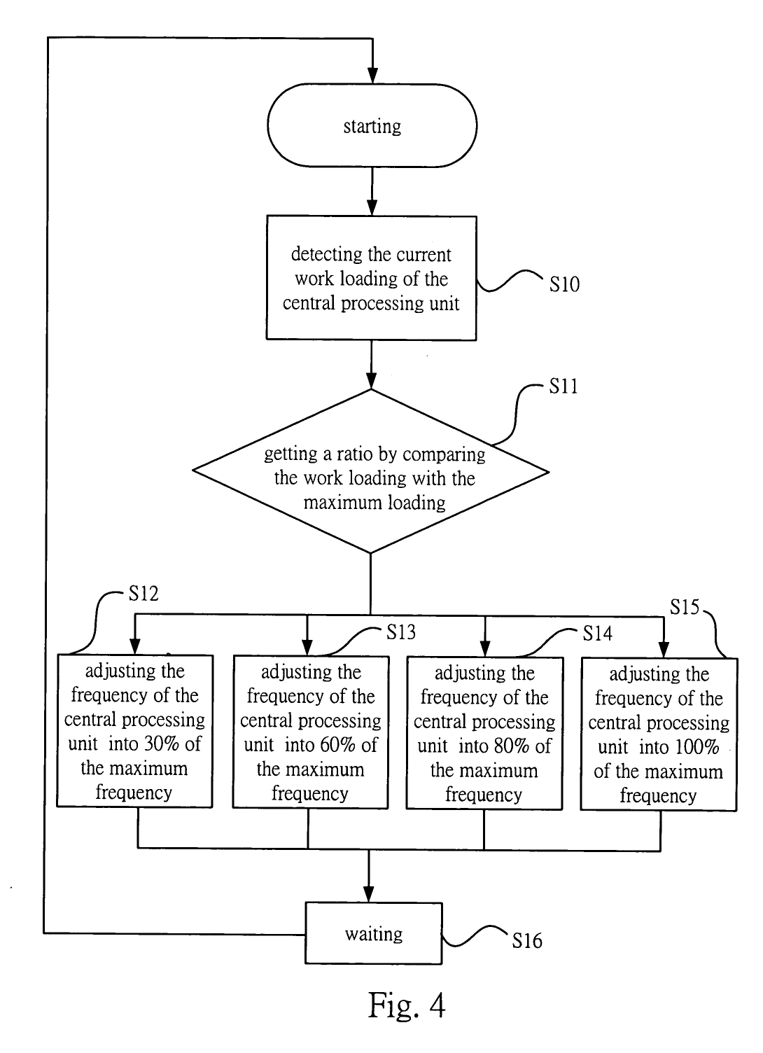

Refer to FIG. 4, a flow chart showing the power control unit 40 detecting and adjusting frequency of the central processing unit 55. As shown in step S10, the power control unit 40 in accordance with the present invention detects the current work loading of the central processing unit 55. Then the work loading being detected is compared with the maximum loading of the central processing unit 55 to get a ratio, as shown in step S11. If the ratio is between 0%-25%, go to step 12 for adjusting the frequency of the central processing unit 55 into 30% of the maximum frequency. In similar way, when the detected loading of the central processing unit 55 is between 25%˜50%, 50%˜75%, or 75%˜100% of the maximum loading thereof, go to step S13, S14, S15 for adjusting the frequency into 60%, 80%, and 100% of the maximum frequency of the central processing unit 55 respectively. At last, as shown in step S16, after waiting for a period of time such as 1 second, restart the above detecting and adjusting steps again. Following this flow, the loading and frequency of the central processing unit 55 are always adjusted so as to reduce the voltage for saving electricity.

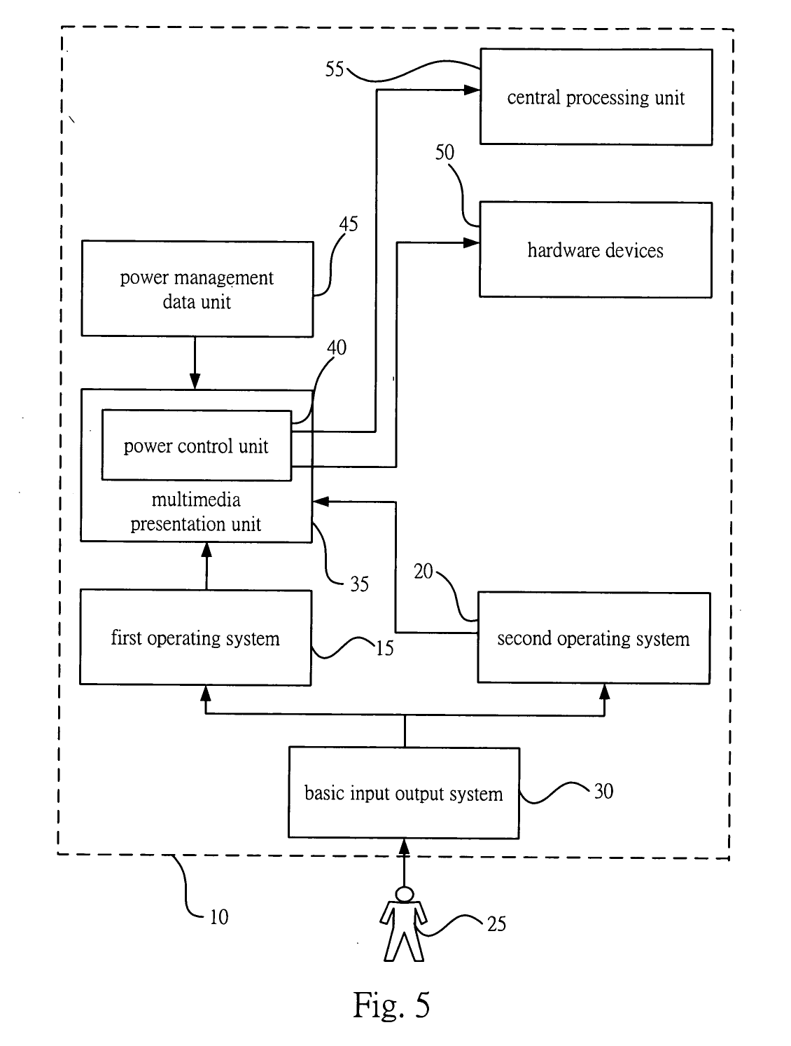

Refer to FIG. 5, a block diagram of another embodiment in accordance with the present invention is disclosed. The difference between this embodiment and the above embodiment is that the power control unit 40 is included inside the multimedia presentation unit 35. That is, when users 25 activate the multimedia presentation unit 35, the power control unit 40 is also turned on at the same time and it retrieves corresponding data from the power management data unit 45 according to the executed program inside the multimedia presentation unit 35 so as to switch on relative computer hardware devices for executing the programs and shut down unemployed hardware devices of the computer system. Then the power control unit 40 further adjusts the frequency of the central processing unit 55 so as to achieve the lower electricity consumption of the computer system 10.

In summary, a computer power management architecture and a method thereof in accordance with the present invention includes a power control unit 40 retrieves information from a power management data unit 45 according to the programs executed by a multimedia presentation unit 35 operated by users 25. Thus the related hardware devices 50 in computer system 10 for programs are switched on and other idle hardware devices 50 are shutdown temporarily so as to save electricity. Moreover, the frequency of a central processing unit 55 is also adjusted so as to reduce the frequency for lower power consumption. Furthermore, the computer system 10 of the present invention has no instant monitoring of the hardware devices 50 so that the loading of the central processing unit 55 is reduced.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A computer power management architecture of a computer system comprising:
a first operating system with at least an application program installed in a computer system;
a second operating system with lower system resource consumption installed in the computer system;
a multimedia presentation unit for running audio/video programs;
a power management data unit for storing data regarding hardware devices necessary for each of the programs run by the multimedia presentation unit; the hardware devices necessary for programs are switched on while others are shut off; and
a power control unit for retrieving the data from the power management data unit according to the programs run by the multimedia presentation unit and turning on hardware devices of the computer system necessary for the program run by the multimedia presentation unit and switching off other idle hardware devices according to the retrieved data corresponding to the program.

2. The device according to claim 1, wherein the power management data unit further stores data of frequency of a central processing unit in the computer system, corresponding to each programs run by the multimedia presentation unit and the power control unit adjusts the frequency of the central processing unit according to the data of frequency.

3. The device according to claim 1, wherein the power control unit further detects current loading of a central processing unit of the computer system for adjusting frequency of the central processing unit according to the detected measurements of loading.

4. The device according to claim 1, wherein the second operating system shares the application program with the first operating system.

5. The device according to claim 1, wherein the first operating system is a Windows operating system.

6. The device according to claim 1, wherein the second operating system is a Linux operating system.

7. The device according to claim 1, wherein the multimedia presentation unit is installed in the first operating system.

8. The device according to claim 1, wherein the multimedia presentation unit is installed in the second operating system.

9. The device according to claim 1, wherein the multimedia presentation unit is used to play compact disk (CD), MPEG-1 Audio Layer 3 (MP3), digital versatile disc (DVD), Video Compact Disc (VCD), broadcasting, TV programs, or photographs.

10. The device according to claim 1, wherein the power control unit is disposed in the multimedia presentation unit.

11. The device according to claim 1, wherein the power control unit is disposed in the second operating system.

12. The device according to claim 1, wherein the computer system further having a basic input output system (BIOS) for initiating the second operating program.

13. The device according to claim 1, wherein the power control unit turns on a central processing unit, an optical disk drive, a hard disk, a transmission control device, an audio processing device, an amplifier, a speaker as well as an input device and turns off the rest hardware devices while the multimedia presentation unit is playing CD and MP3 music.

14. The device according to claim 1, wherein the power control unit turns on a central processing unit, a TV audio/video processing device, a hard disk, a transmission control device, a video processing device, an audio processing device, an amplifier, a speaker as well as an input device and turns off the rest hardware devices while the multimedia presentation unit is playing TV programs.

15. The device according to claim 1, wherein the power control unit turns on a central processing unit, an optical disk drive, a hard disk, a transmission control device, a video processing unit, an audio processing device, an amplifier, a speaker as well as an input device and turns off the rest hardware devices while the multimedia presentation unit is playing VCD and DVD.

16. The device according to claim 1, wherein the power control unit turns on a central processing unit, a broadcast audio receiving and processing device, a hard disk, a transmission control device, an audio processing device, an amplifier, a speaker as well as an input device and turns off the rest hardware devices while the multimedia presentation unit is playing broadcasting programs.

17. The device according to claim 1, wherein the power control unit turns on a central processing unit, an optical disk drive, a hard disk, a transmission control device, a video processing device, an audio processing device, an amplifier, a speaker as well as an input device and turns off the rest hardware devices while the multimedia presentation unit is playing photographs.

18. A power management method for a computer system comprising following steps: installing a first operating system and a second operating system with lower system resource consumption in a computer system; retrieving data corresponding to programs from a power management data unit by a power control unit when a multimedia presentation unit in the computer system displays audio/video programs; switching on hardware devices of the computer system necessary for running the programs in the multimedia presentation unit and switching off the rest idle hardware devices by the power control unit.

19. The power management method for computer systems as claimed in claim 18, wherein the data stored in the power management data unit is corresponding to each of the programs run by the multimedia presentation unit, regarding the hardware devices which should be turned on or turned off in the computer systems.

20. The power management method for computer systems as claimed in claim 18, wherein the power management method further having a step: the power control unit adjusting frequency of a central processing unit according to the audio/video programs run by the multimedia presentation unit.

21. The power management method for computer systems as claimed in claim 20, wherein the power control unit retrieves data from the power management data unit while the data relates to frequency of a central processing unit in the computer system, corresponding to each of the programs run by the multimedia presentation unit.

22. The power management method for computer systems as claimed in claim 18, wherein the power management method further having a step: detecting current loading of a central processing unit of the computer system and adjusting the frequency of the central processing unit to a lower level according to the detected measurements of the loading by the power control unit.

23. The power management method for computer systems as claimed in claim 22, wherein the power control unit adjusts the frequency of the central processing unit into 30% of the maximum frequency of the central processing unit when the current loading of the central processing unit is between 0%˜25% of the maximum loading of the central processing unit.

24. The power management method for computer systems as claimed in claim 22, wherein the power control unit adjusts the frequency of the central processing unit into 60% of the maximum frequency of the central processing unit when the current loading of the central processing unit is between 25%˜50% of the maximum loading of the central processing unit.

25. The power management method for computer systems as claimed in claim 22, wherein the power control unit adjusts the frequency of the central processing unit into 80% of the maximum frequency of the central processing unit when the current loading of the central processing unit is between 50%˜75% of the maximum loading of the central processing unit.

26. The power management method for computer systems as claimed in claim 22, wherein the power control unit adjusts the frequency of the central processing unit into the maximum frequency of the central processing unit when the current loading of the central processing unit is between 75%˜100% of the maximum loading of the central processing unit.

27. The power management method for computer systems as claimed in claim 18, wherein the first operating system having at least one application program.

28. The power management method for computer systems as claimed in claim 27, wherein the application program of the first operating system is capable of being used by the second operating system.

29. The power management method for computer systems as claimed in claim 18, wherein the first operating system is a Windows operating system.

30. The power management method for computer systems as claimed in claim 18, wherein the second operating system is a Linux operating system.

31. The power management method for computer systems as claimed in claim 18, wherein the multimedia presentation unit is installed in the first operating system.

32. The power management method for computer systems as claimed in claim 18, wherein the multimedia presentation unit is installed in the second operating system.

33. The power management method for computer systems as claimed in claim 18, wherein the multimedia presentation unit is used to play compact disk (CD), MPEG-1 Audio Layer 3 (MP3), digital versatile disc (DVD), Video Compact Disc (VCD), broadcasting, TV programs, or photographs.

34. The power management method for computer systems as claimed in claim 18, wherein the power control unit is disposed in the multimedia presentation unit.

35. The power management method for computer systems as claimed in claim 18, wherein the power control unit is disposed in the second operating system.

36. The power management method for computer systems as claimed in claim 18, wherein the power control unit turns on a central processing unit, an optical disk drive, a hard disk, a transmission control device, an audio processing device, an amplifier, a speaker as well as an input device and turns off the rest hardware devices while the multimedia presentation unit is playing CD and MP3 music.

37. The power management method for computer systems as claimed in claim 18, wherein the power control unit turns on a central processing unit, a TV audio/video processing device, a hard disk, a transmission control device, a video processing device, an audio processing device, an amplifier, a speaker as well as an input device and turns off the rest hardware devices while the multimedia presentation unit is playing TV programs.

38. The power management method for computer systems as claimed in claim 18, wherein the power control unit turns on a central processing unit, an optical disk drive, a hard disk, a transmission control device, a video processing unit, an audio processing device, an amplifier, a speaker as well as an input device and turns off the rest hardware devices while the multimedia presentation unit is playing VCD and DVD.

39. The power management method for computer systems as claimed in claim 18, wherein the power control unit turns on a central processing unit, a broadcast audio receiving and processing device, a hard disk, a transmission control device, an audio processing device, an amplifier, a speaker as well as an input device and turns off the rest hardware devices while the multimedia presentation unit is playing broadcasting programs.

40. The power management method for computer systems as claimed in claim 18, wherein the power control unit turns on a central processing unit, an optical disk drive, a hard disk, a transmission control device, a video processing device, an audio processing device, an amplifier, a speaker as well as an input device and turns off the rest hardware devices while the multimedia presentation unit is playing photographs.

41. A computer power management architecture of a computer system comprising:
a multimedia presentation unit for running audio/video programs;
a power management data unit for storing data regarding hardware devices for the programs run by the multimedia presentation unit; the hardware devices necessary for programs are switched on while others are shut off; and
a power control unit for retrieving the data from the power management data unit according to the programs run by the multimedia presentation unit and turning on hardware devices of the computer system necessary for the program run by the multimedia presentation unit and switching off other idle hardware devices according to the retrieved data corresponding to the program.

42. The device according to claim 41, wherein the power management data unit further stores data of frequency of a central processing unit in the computer system, corresponding to each programs run by the multimedia presentation unit and the power control unit adjusts the frequency of the central processing unit according to the data of frequency.

43. The device according to claim 41, wherein the power control unit further detects current loading of a central processing unit of the computer system for adjusting frequency of the central processing unit according to the detected measurements of loading.

44. The device according to claim 41, wherein the multimedia presentation unit is used to play compact disk (CD), MPEG-1 Audio Layer 3 (MP3), digital versatile disc (DVD), Video Compact Disc (VCD), broadcasting, TV programs, or photographs.

45. The device according to claim 41, wherein the power control unit is disposed in the multimedia presentation unit.

46. The device according to claim 41, wherein the power control unit is disposed in one of the operating systems in the computer system.

47. The device according to claim 41, wherein the power control unit turns on a central processing unit, an optical disk drive, a hard disk, a transmission control device, an audio processing device, an amplifier, a speaker as well as an input device and turns off the rest hardware devices while the multimedia presentation unit is playing CD and MP3 music.

48. The device according to claim 41, wherein the power control unit turns on a central processing unit, a TV audio/video processing device, a hard disk, a transmission control device, a video processing device, an audio processing device, an amplifier, a speaker as well as an input device and turns off the rest hardware devices while the multimedia presentation unit is playing TV programs.

49. The device according to claim 41, wherein the power control unit turns on a central processing unit, an optical disk drive, a hard disk, a transmission control device, a video processing unit, an audio processing device, an amplifier, a speaker as well as an input device and turns off the rest hardware devices while the multimedia presentation unit is playing VCD and DVD.

50. The device according to claim 41, wherein the power control unit turns on a central processing unit, a broadcast audio receiving and processing device, a hard disk, a transmission control device, an audio processing device, an amplifier, a speaker as well as an input device and turns off the rest hardware devices while the multimedia presentation unit is playing broadcasting programs.

51. The device according to claim 41, wherein the power control unit turns on a central processing unit, an optical disk drive, a hard disk, a transmission control device, a video processing device, an audio processing device, an amplifier, a speaker as well as an input device and turns off the rest hardware devices while the multimedia presentation unit is playing photographs.

52. A power management method for a computer system comprising following steps: retrieving data corresponding to programs run in a power management data unit by a power control unit when audio/video programs run by a multimedia presentation unit in a computer system operated by users; switching on hardware devices of the computer system necessary for running the programs in the multimedia presentation unit and switching off the rest idle hardware devices by the power control unit in the computer system.

53. The power management method for computer systems as claimed in claim 52, wherein the data stored in the power management data unit is corresponding to each of the programs run by the multimedia presentation unit, regarding the hardware devices which should be turned on or turned off in the computer systems.

54. The power management method for computer systems as claimed in claim 52, wherein the power management method further having a step: the power control unit adjusts frequency of a central processing unit according to the audio/video programs run by the multimedia presentation unit.

55. The power management method for computer systems as claimed in claim 54, wherein the power control unit retrieves data from the power management data unit while the data relates to frequency of a central processing unit in the computer system, corresponding to each of the programs run by the multimedia presentation unit.

56. The power management method for computer systems as claimed in claim 52, wherein the power management method further having a step: detecting current loading of a central processing unit of the computer system and adjusting the frequency of the central processing unit to a lower level according to the detected measurements of the loading by the power control unit.

57. The power management method for computer systems as claimed in claim 56, wherein the power control unit adjusts the frequency of the central processing unit into 30% of the maximum frequency of the central processing unit when the current loading of the central processing unit is between 0%˜25% of the maximum loading of the central processing unit

58. The power management method for computer systems as claimed in claim 56, wherein the power control unit adjusts the frequency of the central processing unit into 60% of the maximum frequency of the central processing unit when the current loading of the central processing unit is between 25%˜50% of the maximum loading of the central processing unit

59. The power management method for computer systems as claimed in claim 56, wherein the power control unit adjusts the frequency of the central processing unit into 80% of the maximum frequency of the central processing unit when the current loading of the central processing unit is between 50%˜75% of the maximum loading of the central processing unit

60. The power management method for computer systems as claimed in claim 56, wherein the power control unit adjusts the frequency of the central processing unit into the maximum frequency of the central processing unit when the current loading of the central processing unit is between 75%˜100% of the maximum loading of the central processing unit

61. The power management method for computer systems as claimed in claim 52, wherein the multimedia presentation unit is used to play compact disk (CD), MPEG-1 Audio Layer 3 (MP3), digital versatile disc (DVD), Video Compact Disc (VCD), broadcasting, TV programs, or photographs.

62. The power management method for computer systems as claimed in claim 52, wherein the power control unit is disposed in the multimedia presentation unit.

63. The power management method for computer systems as claimed in claim 52, wherein the power control unit is disposed in one of the operating systems in the computer system.

64. The power management method for computer systems as claimed in claim 52, wherein the power control unit turns on a central processing unit, an optical disk drive, a hard disk, a transmission control device, an audio processing device, an amplifier, a speaker as well as an input device and turns off the rest hardware devices while the multimedia presentation unit is playing CD and MP3 music.

65. The power management method for computer systems as claimed in claim 52, wherein the power control unit turns on a central processing unit, a TV audio/video processing device, a hard disk, a transmission control device, a video processing device, an audio processing device, an amplifier, a speaker as well as an input device and turns off the rest hardware devices while the multimedia presentation unit is playing TV programs.

66. The power management method for computer systems as claimed in claim 52, wherein the power control unit turns on a central processing unit, an optical disk drive, a hard disk, a transmission control device, a video processing unit, an audio processing device, an amplifier, a speaker as well as an input device and turns off the rest hardware devices while the multimedia presentation unit is playing VCD and DVD.

67. The power management method for computer systems as claimed in claim 52, wherein the power control unit turns on a central processing unit, a broadcast audio receiving and processing device, a hard disk, a transmission control device, an audio processing device, an amplifier, a speaker as well as an input device and turns off the rest hardware devices while the multimedia presentation unit is playing broadcasting programs.

68. The power management method for computer systems as claimed in claim 52, wherein the power control unit turns on a central processing unit, an optical disk drive, a hard disk, a transmission control device, a video processing device, an audio processing device, an amplifier, a speaker as well as an input device and turns off the rest hardware devices while the multimedia presentation unit is playing photographs.
